(19) United States
(12) Patent Application Publication
(10) Pub. No.: US 2005/0116492 A1
(43) Pub. Date: Jun. 2, 2005

(54) Safety travel tailgate with eagle eye perfect view mirror

(76) Inventor: Jerry W. Wiley, Palm Desert, CA (US)

Correspondence Address: JERRY W. WILEY, 40900 AVENIDA ESTRADA, PALM DESERT, CA, 92260, US

(21) Appl. No.: 10/724,597

(22) Filed: Dec. 1, 2003

(51) Int. Cl. B62D 33/03

(52) U.S. Cl. 296/57.1

(57) ABSTRACT

This invention submission pertains to the automotive industry, specifically for Pickup Trucks. This invention is for any pickup truck or vehicle with a tailgate. The newly designed tailgate folds forward and lays into a 2″-3″ recessed area of the pickup truck bed. The idea of this invention has many positives. The new design eliminates any blind spots behind the vehicle, increasing the drivers visibility and safety and also increases fuel economy since there is no wind resistance from the tailgate being in the closed position and easier loading and unloading capabilities. The Safety Travel Tailgate can be offered in a manual or automatic model. In addition to the redesign of the tailgate, The Eagle Eye Perfect View Mirror contains both a normal traffic vision, and downward angle vision, which increases the vision behind the vehicle, without having to adjust the mirror.

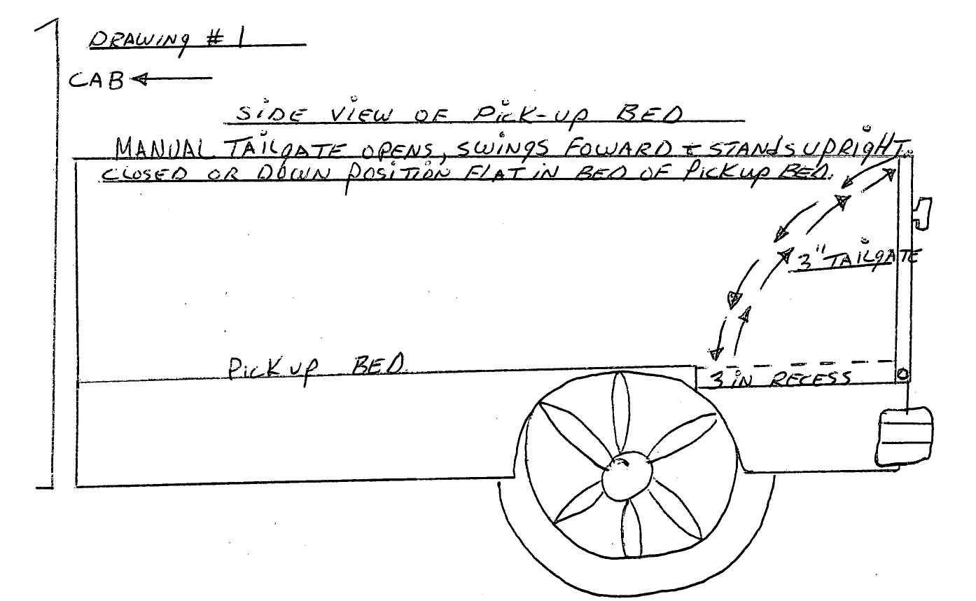

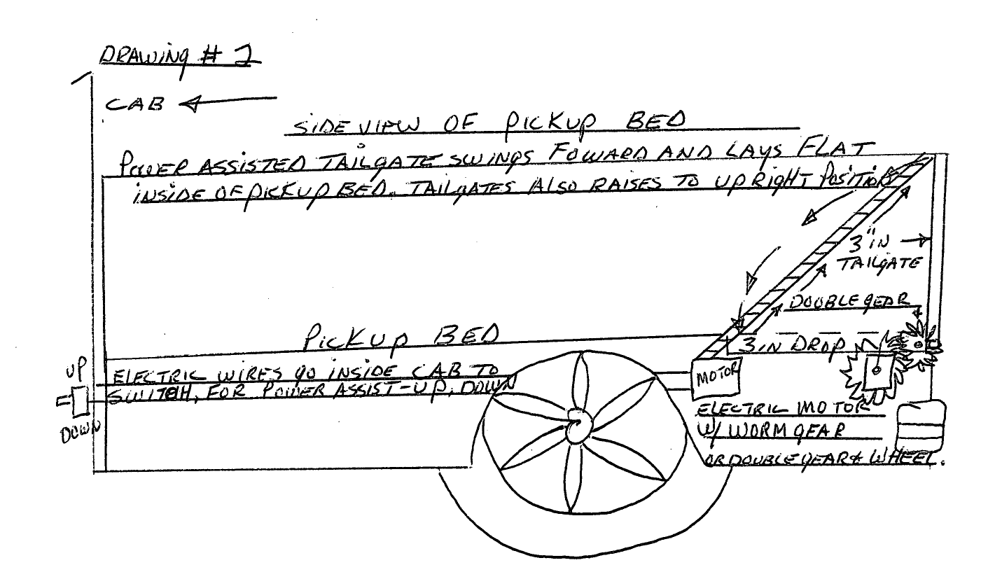

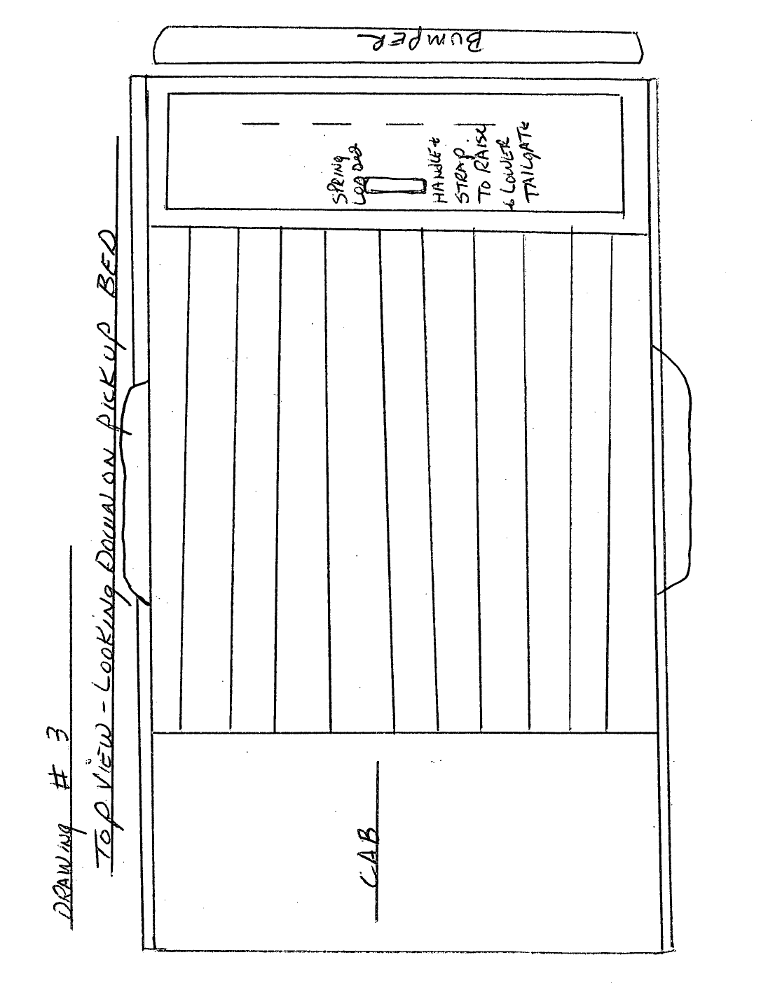

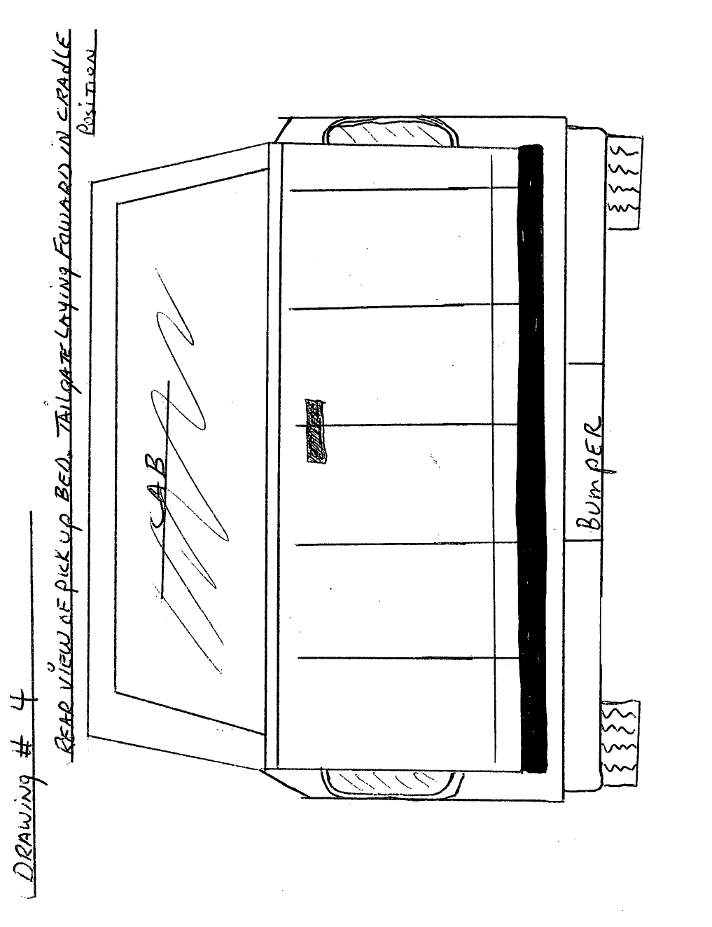

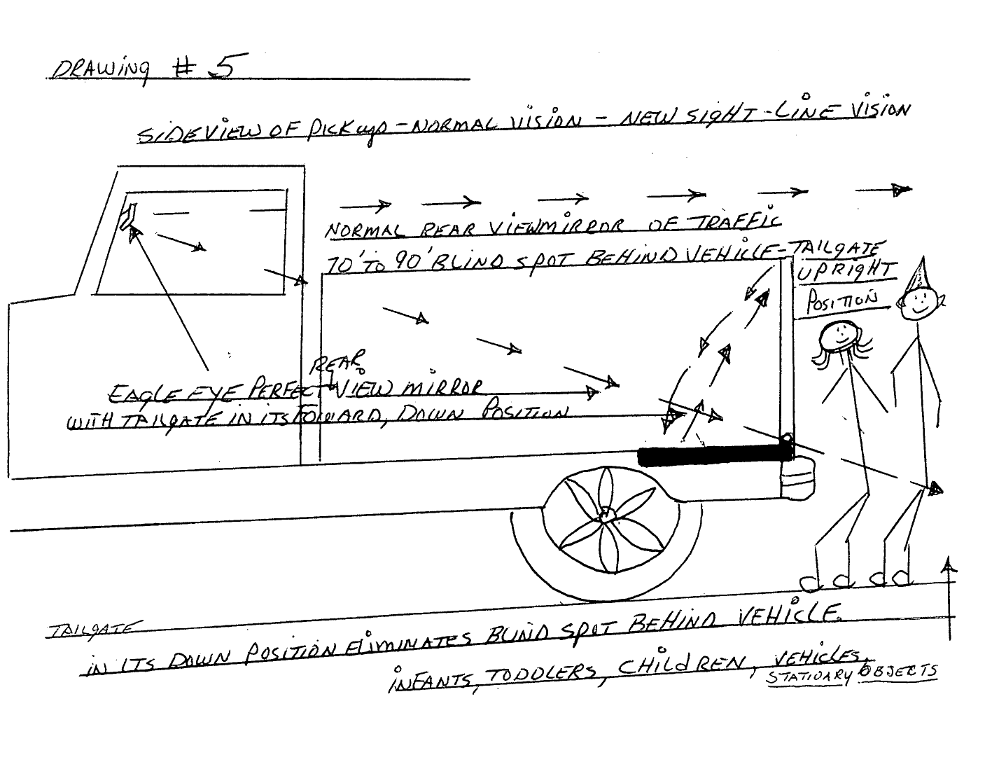

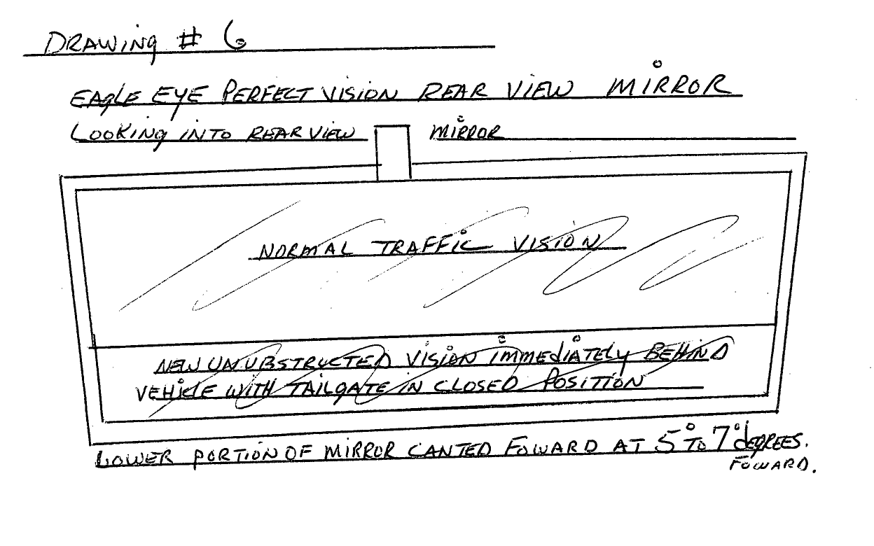

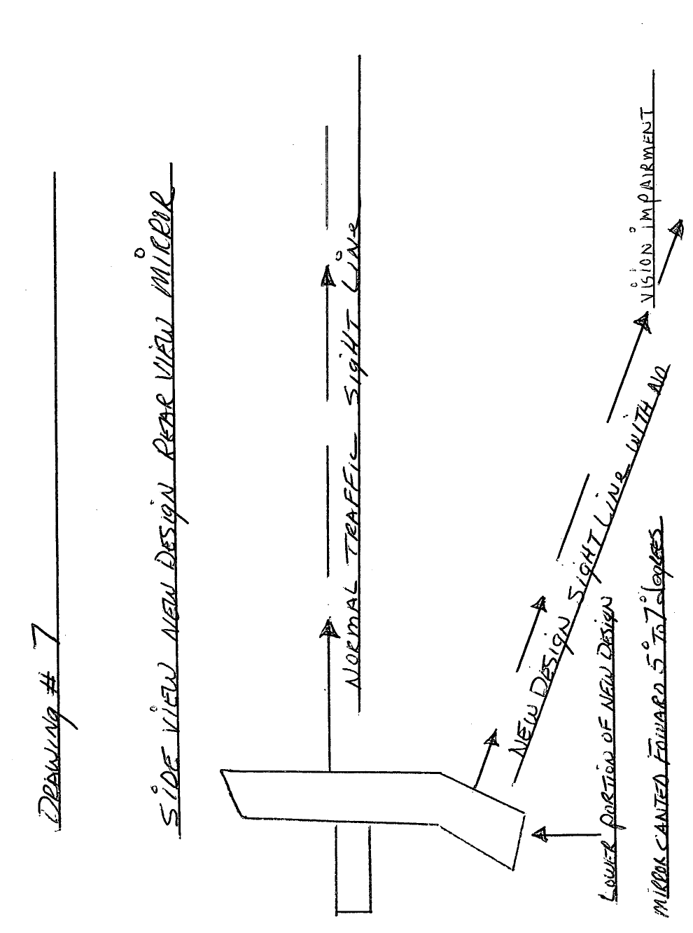

### BACKGROUND OF INVENTION

I became aware of this invention when I traveled from Palm Desert, Calif. to Amarillo, Tex. At the time of my travels gasoline prices were up well over two-dollars a gallon. Being retired and having been involved my entire life with automobiles I came up with the idea to open the tailgate of my truck in hopes of increasing the gas mileage by a few miles per gallon. To my amazement it worked. Just by opening the tailgate I increased the miles per gallon by two to three. I did not need to stop as frequently to re-fuel. A savings of time and money.

Having many hours to think about the vast possibilities of redesigning a pick up truck bed tailgate I also began to question the issues of safety as the poor visibility for the driver due to the tailgate being up and inability to see what is on the other side of the tailgate.

The pick up truck tailgates have had the same design since their inception in the 1920's. Why is it some eighty years later the industry is still utilizing the same, unsafe design? I feel that it is the perfect time to redesign it and come up with a better, safer and more flexible design for the industry and the consumer.

The pick up truck tailgate design have always had only two positions. Open and closed. The main position or normal position is in the closed or upright position. Unlatching the tailgate allows the tailgate to swing open or down to a horizontal or flat position, even with the bed of the truck. I believe the current tailgate design and hardware function have an inherent limited design, which creates extremely poor visibility, fuel economy when in the normal, upright position and poor loading capability when in the open position.

When a tailgate is open, it extends approximately 2 feet beyond the bed of the truck, which could cause a driver to become less familiar with the truck due to the added length. Having the tailgate closed has caused many backing accidents because of the poor visibility. Accidents, which include property damage, injuries and death. I am not aware of any manufactures products that operate in any other way.

My invention provides that the new design of a pick up truck tailgate swings/folds forward and down into a recessed area of the truck bed, as well as the current traditional design.

### BRIEF SUMMARY OF THE INVENTION

The need for the Safety Travel Tailgate and Eagle Eye perfect view Mirror has many benefits not to be ignored. They are:
Increased Visibility
Increased Safety
Increased Fuel Economy
Better/Easier Loading Capability

The increased visibility with the redesign of the down/closed position will provide a driver with 50-60 percent greater visibility at the rear of the truck.

The increased safety will prevent numerous backing accidents, injuries and deaths because the drivers will have a better view of what is behind the truck, when backing.

The increased fuel economy speaks for itself. Having the tailgate in the down or closed position inside the bed of the truck will increase the fuel mileage by 1½ to 2 miles per gallon due to zero wind resistance against a current, closed tailgate. This major improvement in fuel economy will save millions of gallons of fuel every year for the future of this country. Manufacturers will also find it somewhat easier to comply with the strict EPA standards.

The better/easier loading capability is something that everyone looks forward to. Having the tailgate folded flat inside the pickup bed will allow the person loading to not have to reach as far into the bed of the truck to load. A good example is the Barn Door design of SUV vehicles. Many of my friends and family members have owned SUV's with and without barn doors. When I asked their preference all of them indicated their desire for barn doors due to being closer to the bed or inside of the vehicle for loading.

### DETAILED DESCRIPTION

The new design of the Safety Travel Tailgate will revolutionize the pick up truck industry by giving consumers more flexibility with a current, non-flexible design. Safety and increased fuel economy is what should drive this new invention.

The new tailgate 3″ thick will fold forward into a 3½″ in recessed area of the truck bed. The tailgate will now be perfectly level with the pickup bed. The tailgate will also have the capability to be used in the upright/closed position for hauling.

A plastic or rubber handle will be installed and recessed into the outside of the tailgate. The new handle will have a nylon strap attached to it. The other end of the strap attached to a spring-loaded reel. The purpose of the new handle is to raise and lower the tailgate.

Modifications to the truck bed will include a redesign to included 3½″ of drop at the rear of the bed. The inside rear support posts will need to be redesigned and modified to allow the tailgate to fold forward into the recessed area of the bed. Locking latches will be reversed in order to lock the tailgate into the upright/closed position. The hinges must be raised 1-2 inches to allow for the tailgate to fold inside of the bed.

The new, normal position of the tailgate will be laying or folded into the recessed truck bed. In order to prevent scratching to the outside of the tailgate a scuff-proof, non-marking material will be applied to the tailgate to match the color of the rest of the truck.

The Safety Travel Tailgate will be offered and designed with a manual operation as well as electric or automatic design to give that much more flexibility to the owner of the vehicle. If the driver wishes to utilize the tailgate in the normal or down position a cargo net should be used to contain the load.

An integral portion of the newly designed pick up truck bed is the design of the Eagle Eye Perfect View Mirror. This new mirror will contain a lower, second mirror attached to the existing rearview mirror. This second mirror will be tilted forward at 5-7 degree to allow for maximum visibility out the rear of the truck. This mirror allows the driver to see behind the truck without having to change the position as you would a traditional rear-view mirror. A 50-60 percent increase in rear visibility behind the truck is expected with the new Safety Travel Tailgate and Eagle Eye Perfect View Mirror.

### SPECIFICATIONS

### Manual Tailgate

### Safety Travel Tailgate

Pickup Truck Tailgate 3″ thick.
3½″ recessed pickup bed to allow newly designed tailgate to lie flat inside the bed of the truck.
Newly designed tailgate hinges to allow tailgate to fold out, up and into the bed of the truck into the recessed bed. Hinges to be mounted 1″-2″ higher to allow tailgate to fold forward, into the bed of the pickup truck.
Tailgate latching mechanism to accommodate the three positions of the new design of the pickup tailgate and bed of truck. Latching mechanism to accommodate tailgate to fold out, up and into the bed of the truck.
Pick up truck bed side-supports will require some minor design modifications to allow for the tailgate to fold into the bed of the truck and into it's recessed area.
Pick up truck bed will require a minor design modification to allow for the tailgate to fold into the bed of the truck and into its recessed area.
A heavy-duty handle will be recessed into the tailgate, near the open/close latch. The new heavy-duty handle will have a nylon strap attached. The other end attached to a spring-loaded reel. The purpose of the new tailgate handle is to move the tailgate into the desired position.
An integral part of the Safety Travel Tailgate is a newly designed cab rearview mirror. The top portion of the rearview mirror is to be used for normal driving and traffic viewing. The bottom portion of the rearview mirror to be designed so it is tilted 5-7 degrees to allow the driver to see behind the truck with greater visibility without having to adjust the mirror.

### VIEWS OF DRAWINGS

1. Side view of pick up truck bed showing tailgate in new down position or upright position. Manual tailgate.

2. Side view power operated tailgate with worm gear or traditional gear driven motor.

3. Rear view of pick up truck showing tailgate in new down position, recessed into bed of truck.

4. Top view of pick up truck showing tailgate in the down position, recessed into bed of truck.

5. Side view of pick up truck showing new design of rearview mirror.

I. Idea to redesign a pickup truck tailgate to fold inside, into bed of truck.

II. Idea to redesign a pickup truck bed to include recessed area where the tailgate will lay flush with the bed of the truck.

III. Idea to redesign pickup truck bed and side supports to accommodate the tailgate to be folded into the bed of the truck.

IV. Idea to redesign tailgate hinges to operate in a three-way ability,

V. Idea to redesign tailgate handle to accommodate the three-way operation of the tailgate.

VI. Idea to design a mirror that is stationary that provides better visibility when backing.

VII. Idea to utilize a scratch resistant, color matched material the will replace the painted tailgate.
